(19) United States
(12) Patent Application Publication
(10) Pub. No.: US 2018/0141752 A1
(43) Pub. Date: May 24, 2018

(54) TRANSPORT DEVICE AND RACK MOUNTED THEREON

(71) Applicant: Panasonic Intellectual Property Management Co., Ltd., Osaka (JP)

(72) Inventors: TSUTOMU NAKANISHI, Osaka (JP); TAKESHI UEMURA, Osaka (JP); YORIKO NAKAO, Kyoto (JP); TAKAHIRO AKIYOSHI, Osaka (JP)

(21) Appl. No.: 15/570,481

(22) PCT Filed: Apr. 26, 2016
(86) PCT No.: PCT/JP2016/002200

§ 371 Date: Oct. 30, 2017

Related U.S. Application Data
(60) Provisional application No. 62/160,975, filed on May 13, 2015.
(60) Provisional application No. 62/160,992, filed on May 13, 2015.

(51) Int. Cl. B65G 1/137; B61B 13/02; B65G 1/10; B66F 9/07

(52) U.S. Cl. CPC B65G 1/137; B61B 13/02; B65G 2203/042; B66F 9/07; B65G 1/10

(57) ABSTRACT

A transport device includes a main body section, a base connected to the main body section, a wheel connected to the main body section for causing the transport device to travel, a drive module for driving the wheel, and a sensor that detects a state of the transport device, wherein a posture of the main body section is controlled using an output of the sensor such that the center of gravity of a mounted object approaches the center of gravity of the transport device.

### TECHNICAL FIELD

The present disclosure relates to a device for transporting a loaded object while controlling a posture.

### BACKGROUND ART

Conventionally, a device which has a main body section having wheels and a base attached to the main body section, and which automatically travels with a mounted object being mounted on the base has been embodied (see PTL 1).

### CITATION LIST

### Patent Literature

PTL 1: Japanese Patent No. 5138681

### SUMMARY OF THE INVENTION

However, PTL 1 has such a problem that, during transportation of a mounted object, the posture of the device is not stable with the mounted object being mounted.

To address the foregoing problem, a transport device according to the present disclosure includes a device main body section for mounting a mounted object thereon, and a sensor that detects a state of the device main body section with the mounted object being mounted thereon. The device main body section has a base connected to the device main body section for mounting a mounted object thereon, a wheel connected to the device main body section for causing the transport device to travel, and a drive module for driving the wheel, wherein a posture of the mounted object is controlled by controlling a posture of the device main body section using an output of the sensor so that the center of gravity of the mounted object approaches the center of gravity of the transport device.

According to the configuration described above, the present disclosure can control the posture of the transport device with a loaded object being mounted thereon during transportation of the loaded object.

### BRIEF DESCRIPTION OF DRAWINGS

FIG. 1 is a perspective view of a device according to a first exemplary embodiment of the present disclosure.

FIG. 2A is a view illustrating a state where the device advances toward a rack.

FIG. 2B is a view illustrating a state where the device lifts up the rack.

FIG. 3 illustrates a state where the weight of the rack is non-uniform.

FIG. 4 is a view illustrating a state where the device travels on a slope.

FIG. 5 is a view illustrating an inertial force applied to the device.

FIG. 6 is a view illustrating a rack according to a second exemplary embodiment.

### DESCRIPTION OF EMBODIMENTS

### First Exemplary Embodiment

Hereinafter, transport device 1 according to the first exemplary embodiment, rack 13, and loaded object 14 will be described with reference to the drawings. Herein, a mounted object includes rack 13 and loaded object 14. In the following description, a direction of a side surface of the main body section 2 of transport device 1 is defined as an X-axis direction, a direction of movement of transport device 1 is defined as a Y-axis direction, and a direction of movement of base 3 of transport device 1 is defined as a Z-axis direction.

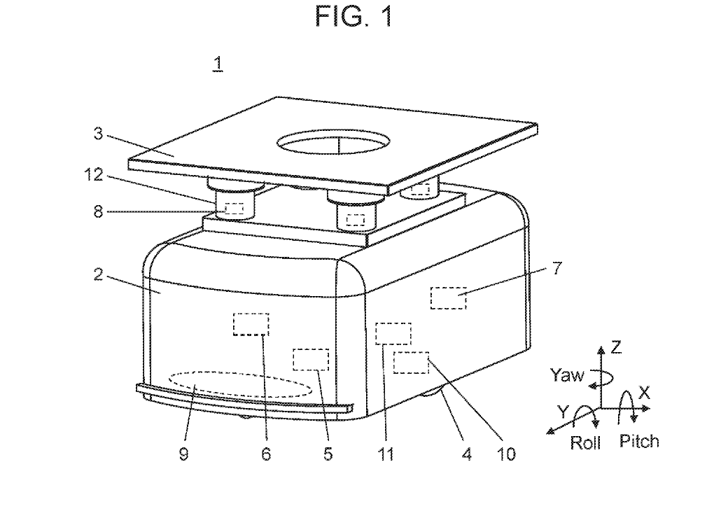

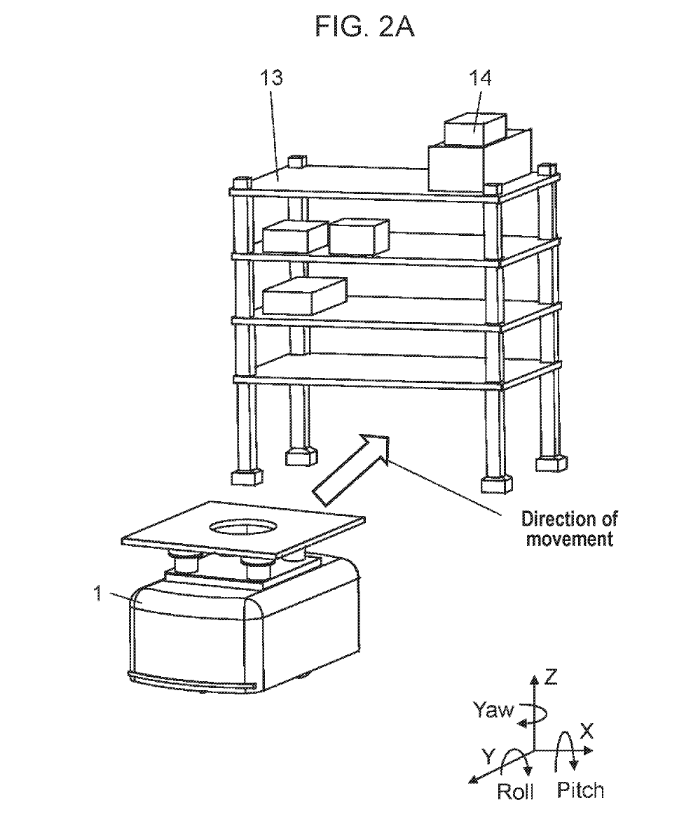

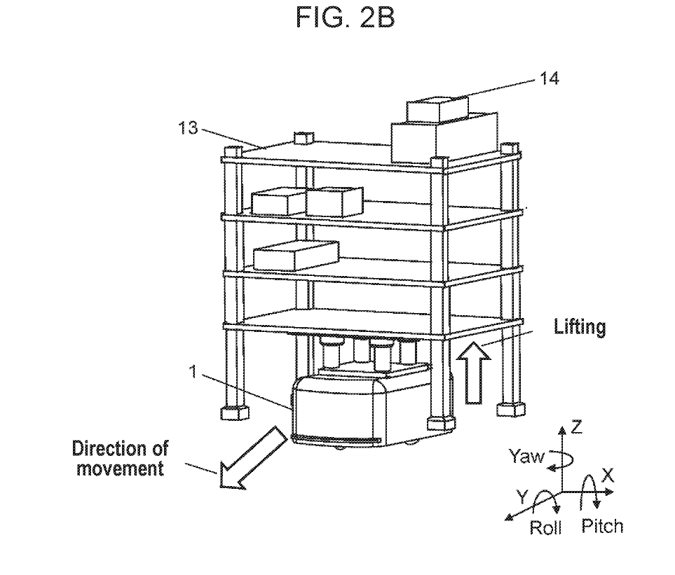

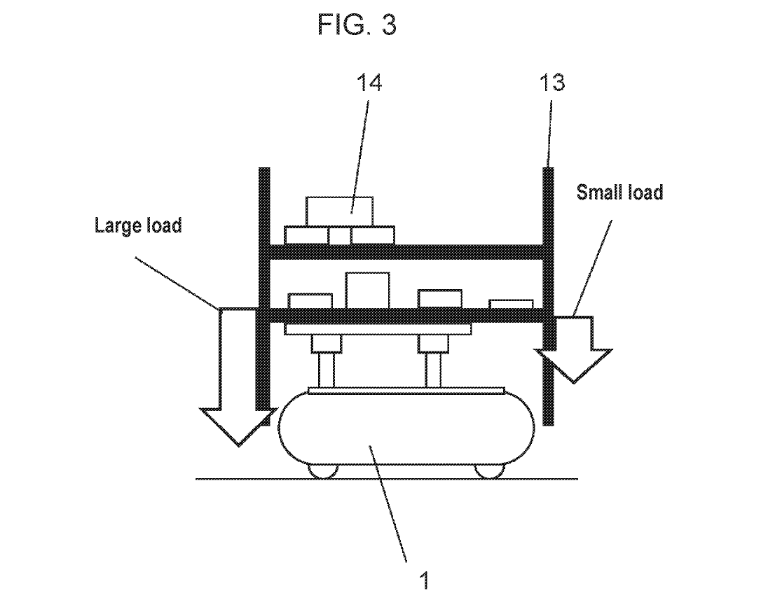

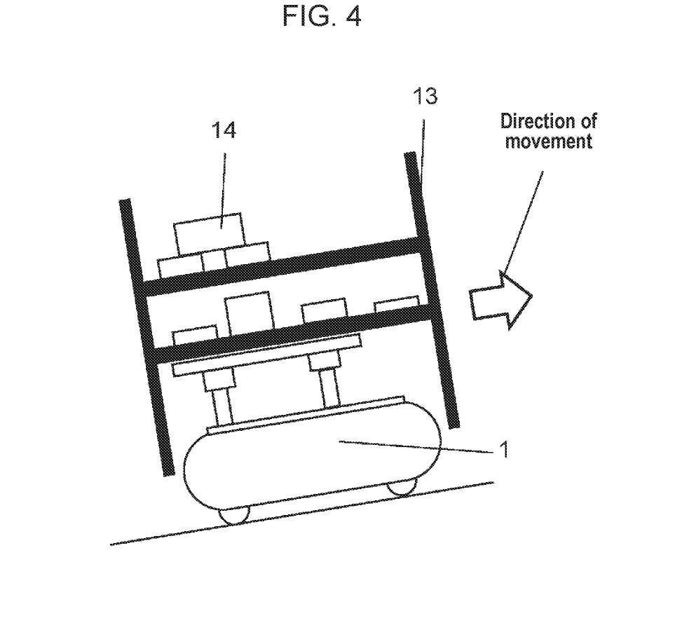

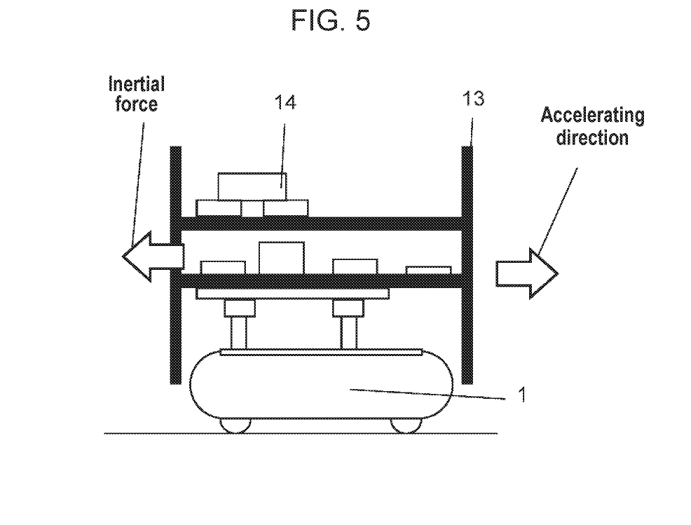

FIG. 1 is a perspective view of transport device 1 according to the first exemplary embodiment of the present disclosure. FIG. 2A is a view illustrating a state where transport device 1 advances toward rack 13, in which an arrow indicates a direction of movement of transport device 1. FIG. 2B is a view illustrating a state where transport device 1 lifts up rack 13, in which arrows indicate lifting of rack 13 and a direction of movement of transport device 1. FIG. 3 is a view illustrating a state where the weight of rack 13 is non-uniform. FIG. 4 is a view illustrating a state where transport device 1 travels on a slope, in which an arrow indicates a direction of movement of transport device 1. FIG. 5 is a view illustrating an inertial force applied to transport device 1, in which arrows indicate an accelerating direction of the transport device and an inertial force applied during acceleration.

As illustrated in FIG. 1, transport device 1 includes: device main body section 2; base 3 connected to a top part of device main body section 2 for mounting a mounted object thereon; wheels 4 connected to a bottom part of main body section 2; drive module 5 that drives and controls wheels 4; angular speed sensor 6; acceleration sensor 7; weight sensor 8; obstacle sensor 9; and wheel speed sensor 10. Transport device 1 also includes battery measurement sensor 11 that measures a remaining capacity of a battery (not illustrated) for supplying electric power to these various electrical components.

Main body section 2 has a rectangular box-shaped outer shape, and has drive module 5 therein. The shape of main body section 2 is not limited to a box shape illustrated in FIG. 1, and can be changed, as appropriate, according to a use condition. Main body section 2 can be moved by wheels 4 driven by drive module 5.

Base 3 is provided on the top part of main body section 2 through actuators 12, and base 3 vertically moves by expansion and contraction of actuators 12 in the Z-axis direction. Actuators 12 are provided to a bottom part of rectangular base 3 at four corners. As illustrated in FIG. 2A, device 1 is moved underneath rack 13 and to the center (middle) of rack 13 as viewed from top. As illustrated in FIG. 2B, main body section 2 is moved underneath rack 13 and base 3 is raised by actuators 12, whereby rack 13 is lifted up. At this point of time, to move main body section 2 underneath rack 13, a control unit (not illustrated) determines an appropriate position based on an output from an image sensor (not illustrated) provided to main body section 2. Instead, main body section 2 can be manually moved by an operator. Further, because four actuators 12 are mounted to main body section 2, an inclination of base 3 relative to main body section 2 can freely be changed by individually changing an amount of expansion and contraction of each actuator 12 in the Z-axis direction. Through the adjustment of the lengths of four actuators 12, the center of gravity of rack 13 is adjusted to substantially coincide with the center of gravity of device 1 as viewed from top. The wording “substantially coincide with” herein includes a deviation to an extent not changing the posture or orientation of rack 13 when device 1 moves. Thus, even when the center of gravity of rack 13 is moved to the rear relative to the advancing direction of device 1 or when the center of gravity position of rack 13 is shifted to a lower part of a slope on which device 1 is present, during movement of device 1 with rack 13 being lifted up, the adjustment of the lengths of four actuators 12 enables the center of gravity of rack 13 to coincide with the center of gravity of device 1 as viewed from top, whereby the posture of rack 13 can be made stable.

Each of actuators 12 is provided with weight sensor 8 that measures the weight of rack 13 lifted up by base 3. Due to weight sensor 8 provided to each of four actuators 12, the weight balance of rack 13 lifted up by base 3 in top view can be measured. The lengths of four actuators 12 in the Z-axis direction can be individually adjusted. Therefore, based on the result of the measurement of the weight of rack 13, the lengths of actuators 12 can be controlled such that the center of gravity position of rack 13 coincides with the center of gravity position of device 1. As described above, device 1 is moved with the center of gravity of rack 13 being substantially coincided with the center of gravity of device 1 by using weight sensors 8, thereby stabilizing the posture of rack 13. This configuration can prevent falling of rack 13 or loaded object 14 on rack 13 from device 1. In addition, four actuators 12 can be individually actuated, and therefore, even when loaded object 14 is unevenly positioned on rack 13, device 1 can be moved with the posture of rack 13 being stabilized. Moreover, the transport speed of device 1 may be changed according to the weight of rack 13. According to this configuration, the braking distance of device 1 can be kept within a desired range. It is to be noted that, while the posture of rack 13 is controlled by individually adjusting the lengths of four actuators 12, the posture of rack 13 may be controlled such that the portion where base 3 and the lower surface of rack 13 are in contact with each other is moved by moving base 3 in the X-axis direction or the Y-axis direction.

Angular speed sensor 6 is provided inside of main body section 2 at a desired position. Due to angular speed sensor 6 being provided, the posture (orientation) change of device 1 in a yaw direction, a roll direction, and a pitch direction caused during movement of device 1 can be detected. Actuators 12 are expanded or contracted in the Z-axis direction based on the detection result of an angular speed, by which the posture of rack 13 can be controlled. According to this configuration, the angular speed of device 1 when crossing a wiring on a passage way on which device 1 travels or when traveling on an uneven part of the passage way is detected, for example, and the lengths of actuators 12 are individually adjusted such that the center of gravity of rack 13 coincides with the center of gravity of device 1 in top view, so that the posture of rack 13 is changed or the speed of base 3 is adjusted. This configuration can prevent damage of loaded object 14 due to collision between loaded objects 14, falling of loaded object 14, or falling of rack 13 from device 1, caused by sway of rack 13.

Acceleration sensor 7 is provided inside of main body section 2 at a desired position. Due to acceleration sensor 7 being provided, an inertial force or inclination caused during movement and transportation of device 1 can be measured. Actuators 12 are expanded or contracted in the Z-axis direction based on the detection result of acceleration, by which the posture of rack 13 can be controlled. This configuration can prevent damage of loaded object 14 due to collision between loaded objects 14, falling of loaded object 14, or falling of rack 13 from device 1, caused by a posture change of device 1 due to an inclination of a road surface. This configuration can also prevent damage of loaded object 14 due to collision between loaded objects 14, falling of loaded object 14, or falling of rack 13 from device 1, caused by an inertial force generated on rack 13 due to a speed change or turning when device 1 starts traveling, travels, or stops.

Obstacle sensor 9 is provided on a front surface (one of surfaces in the Y-axis direction) of main body section 2. Obstacle sensor 9 detects an obstacle such as a falling object present in the advancing direction of device 1. Based on the detection result of obstacle sensor 9, device 1 moves while avoiding an obstacle, or decelerates or stops to prevent collision against the obstacle. This configuration can prevent damage of loaded object 14 due to collision between loaded objects 14, falling of loaded object 14, or falling of rack 13 from device 1, caused by an impact applied to rack 13 due to the collision between device 1 and the obstacle.

Wheel 4 is provided with wheel speed sensor 10 that detects the speed of wheel 4 on device 1. By detecting the speed of each wheel 4 of device 1, a torque generated on each wheel 4 is estimated to detect overturn of device 1. When the loaded weight of device 1 is high and the traveling speed is also high, wheel 4 may slip. However, device 1 can make appropriate deceleration using wheel speed sensor 10, thereby preventing slip of wheel 4.

Device 1 is provided with a battery (not illustrated), and the battery is provided with battery measurement sensor 11. The remaining capacity of the battery is measured by battery measurement sensor 11. For example, when a plurality of devices 1 is used in a factory, the remaining capacity of the battery varies among devices 1. If the timing for charging the battery is fixed to be the same for all devices 1, even a battery of device 1 having a remaining capacity capable of transporting rack 13 with a low loaded weight is also charged. In this case, device 1 cannot make best use of the battery, which leads to a decrease in time efficiency for transportation. However, due to battery measurement sensor 11 being mounted, device 1 having a battery remaining capacity according to the weight of transport rack 13 is optimally disposed, whereby the battery can be used as much as possible and the charging timing can be optimized. Thus, the time efficiency for transportation can be improved.

Next, a method for transporting rack 13 by device 1 thus configured will be described.

As illustrated in FIGS. 2A and 2B, device 1 moves underneath rack 13 in the first step. In the next step, device 1 raises base 3 to lift up rack 13. In the next step, device 1 is moved to a destination. During this movement, the posture of rack 13 is detected by using weight sensors 8. In the next step, device 1 is controlled such that the center of gravity of rack 13 substantially coincides with the center of gravity of device 1 as viewed from top. The posture of rack 13 is controlled by individually controlling four actuators 12 or moving base 3 in the XY plane direction according to the weight of rack 13. At this point of time, the posture of rack 13 is controlled by controlling the transport speed of device 1 to an optimum speed according to the weight of rack 13. In the next step, the acceleration of device 1 is detected, and the posture of rack 13 is controlled according to the acceleration. In the next step, the angular speed of device 1 is detected, and the posture of rack 13 is controlled according to the angular speed. In the next step, the speed of wheels 4 of device 1 is detected, and the posture of rack 13 is controlled according to the speed of wheels 4. Further, when the remaining capacity of the battery becomes low, rack 13 to be transported is optimized according to the remaining capacity of the battery. Moreover, if an obstacle is detected ahead of device 1, an action of avoiding the obstacle is performed.

Notably, the posture control of rack 13 can be performed, if any one of weight sensor 8, angular speed sensor 6, acceleration sensor 7, and wheel speed sensor 10 is provided. If all of these sensors are provided, more accurate posture control can be performed.

### Second Exemplary Embodiment

Hereinafter, a device and a rack according to the second exemplary embodiment will be described with reference to the drawings. In the following description, one direction of the side surface of the rack is defined as an X-axis direction and a Y-axis direction, and the vertical direction of the rack is defined as a Z-axis direction.

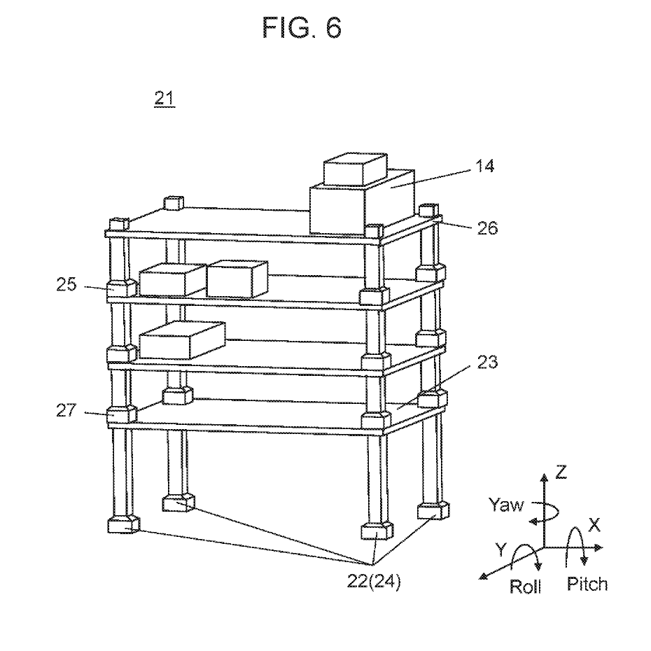

FIG. 6 is a view illustrating the rack according to the second exemplary embodiment.

Device 1 of the second exemplary embodiment receives a signal from rack 21 to be transported to perform more optimum control for device 1. Device 1 further includes a wireless unit (not illustrated) for communicating with rack 21.

Rack 21 is constituted by four legs 22 and a plurality of shelves 23. Rack 21 is provided with weight sensors 24, angular speed sensor 25, acceleration sensor 26, and wireless unit 27 for communicating with device 1.

Device 1 according to the second exemplary embodiment is provided with a communication unit (not illustrated) for communicating with wireless unit 27 of rack 21, but is not provided with a later-described sensor provided to device 1 according to the first exemplary embodiment. Other than the above, device 1 according to the second exemplary embodiment has the same configuration as the configuration of device 1 according to the first exemplary embodiment, and the detailed description thereof will be omitted.

Each leg 22 of rack 21 is provided with weight sensor 24. Due to weight sensor 24 being provided to each leg 22, the output from each weight sensor 24 is transmitted to the communication unit of device 1 through wireless unit 27 of rack 21 to detect the total weight and the center of gravity position of rack 21. In addition, the outputs from respective weight sensors 24 may be calculated by a calculation unit (not illustrated) in rack 21 to calculate the total weight and the center of gravity position of rack 21, and these information may be transmitted to device 1 through wireless unit 27. Because the center of gravity position of rack 21 can be detected, the center of gravity position of rack 21 and the center of gravity position of device 1 can be more accurately coincided with each other by adjusting the lengths of four actuators 12 of device 1. This configuration can prevent damage of loaded object 14 due to collision between loaded objects 14, falling of loaded object 14, or falling of rack 21 from device 1, caused by sway or vibration of rack 21. In addition, the transport speed of device 1 can be optimized according to the total weight of rack 21, and the braking distance of device 1 can be adjusted to be optimum in a wireless manner. Further, device 1 having a battery remaining capacity according to the weight of rack 21 can optimally be disposed, whereby the battery can be used as much as possible and the charging timing can be optimized.

Each shelf 23 of rack 21 is provided with weight sensor 24. Due to weight sensors 24 provided to shelves 23, the center of gravity position of rack 21 in the Z-axis direction can be detected. When rack 21 has the same weight, the higher the center of gravity position in the Z-axis direction is, the more unstable rack 21 becomes. However, when the center of gravity position of rack 21 in the Z-axis direction is detected, an inertial moment of rack 21 caused when device 1 accelerates or when the posture of device 1 is changed can be estimated. According to this configuration, the transport speed of device 1 can be maximized within the range where damage of loaded object 14 due to collision between loaded objects 14, falling of loaded object 14, or falling of rack 21 from device 1 does not occur.

Shelf 23 of rack 21 is provided with angular speed sensor 25. Due to angular speed sensor 25 provided to rack 21, the angular speed caused on rack 21 can be detected. Thus, sway of rack 21 around the X axis and the Y axis is detected by angular speed sensor 25, and actuators 12 of device 1 are controlled according to the angular speed, whereby the posture of rack 21 can be controlled. This configuration can prevent damage of loaded object 14 due to collision between loaded objects 14, falling of loaded object 14, or falling of rack 21 from device 1, caused by sway of rack 21. In addition, because angular speed sensor 25 is provided to shelf 23, it is less affected by disturbance due to vibration, resulting in that the posture of device 1 and rack 21 can be detected with high accuracy. Rack 21 having angular speed sensor 25 being provided to shelf 23 has been described above. However, angular speed sensor 25 may be provided to leg 22 between lowermost shelf 23 and uppermost shelf 23, and with this configuration, the posture of device 1 and rack 21 can also be controlled with high accuracy.

Shelf 23 of rack 21 is provided with acceleration sensor 26. Due to acceleration sensor 7 provided to rack 21, the acceleration caused on rack 21 can be detected. The posture of rack 21 can be controlled in such a way that sway of rack 21 around the X axis, the Y axis, and the Z axis on a certain point is detected based on acceleration and the lengths of actuators in the Z-axis direction are adjusted. This configuration can prevent damage of loaded object 14 due to collision between loaded objects 14, falling of loaded object 14, or falling of rack 21 from device 1, caused by the acceleration exerted on rack 21. In addition, the posture of rack 21 can be controlled with more accuracy by comparing the acceleration with the detection result of acceleration sensor 7 provided to device 1. Note that, if acceleration sensor 26 is provided to uppermost shelf 23 of rack 21, the acceleration can be detected with more accuracy. The same advantageous effect can be obtained when acceleration sensor 26 is provided to leg 22 on the same level as uppermost shelf 23.

Next, a method for controlling device 1 using the detection result of rack 21 will be described.

When rack 21 is transported by device 1, base 3 is raised to lift up rack 21 in the first step. In the next step, device 1 is moved to a destination. During this movement, the posture of rack 21 is detected by using weight sensors 24. In the next step, device 1 is controlled such that the center of gravity of rack 21 substantially coincides with the center of gravity of device 1 as viewed from top. The posture of rack 21 is controlled by individually controlling four actuators 12 or moving base 3 in the XY plane direction according to the weight of rack 21. At this point of time, the posture of rack 21 is controlled by controlling a transport speed of device 1 to an optimum speed according to the weight of rack 21. In the next step, the acceleration of rack 21 is detected, and the posture of rack 21 is controlled according to the acceleration. In the next step, the angular speed of rack 21 is detected, and the posture of rack 21 is controlled according to the angular speed.

### INDUSTRIAL APPLICABILITY

According to the transport device and the rack of the present disclosure, the rack can be transported while the posture of the rack is controlled by detecting the posture of the device and the rack. Therefore, the transport device and the rack of the present disclosure are suitable for transporting a rack in a factory, for example.

### REFERENCE MARKS IN THE DRAWINGS

1: device
2: main body section
3: base
4: wheel
5: drive module
6, 25: angular speed sensor
7, 26: acceleration sensor
8, 24: weight sensor
9: obstacle sensor
10: wheel speed sensor
11: battery measurement sensor
12: actuator
13, 21: rack
14: loaded object
22: leg
23: shelf
27: wireless unit

1. A transport device for transporting a mounted object, comprising:
a device main body section for mounting the mounted object; and
a sensor that detects a state of the device main body section having the mounted object mounted,
wherein the device main body section includes:
a base connected to the device main body section for mounting the mounted object;
a wheel connected to the device main body section for causing the transport device to travel; and
a drive module that drives the wheel, and
a posture of the mounted object is controlled by controlling a posture of the device main body section using an output from the sensor such that a center of gravity of the mounted object approaches a center of gravity of the transport device.

2. The transport device according to claim 1, wherein the sensor is an angular speed sensor.

3. The transport device according to claim 1, wherein the sensor is an acceleration sensor.

4. The transport device according to claim 1, wherein the sensor is a weight sensor that detects a load applied to the base.

5. The transport device according to claim 4, wherein the drive module controls the wheel according to an output of the weight sensor to adjust a travel speed of the transport device.

6. The transport device according to claim 1, wherein
the base further includes a first actuator and a second actuator that raise and lower the base, and
a first weight sensor and a second weight sensor are provided to the base, the first actuator, or the second actuator.

7. The transport device according to claim 6, wherein, when an output of the first weight sensor is larger than an output of the second weight sensor, the first actuator and the second actuator are controlled such that a portion of the base where the first weight sensor is provided is raised.

8. The transport device according to claim 1, wherein the sensor is a sensor that detects a rotational speed of the wheel.

9. The transport device according to claim 1, wherein the sensor is a battery sensor that measures a remaining capacity of a battery provided to the transport device.

10. The transport device according to claim 1, wherein the sensor is an obstacle sensor that detects an object present ahead of the transport device.

11. The transport device according to claim 1, wherein
the mounted object includes a rack and a loaded object loaded on the rack, and
the rack includes the sensor and further includes a wireless unit that transmits an output of the sensor to the device main body section.

12. The rack of the transport device according to claim 11, comprising:
a plurality of shelves; and
a plurality of legs supporting the plurality of shelves.

13. The rack according to claim 12, wherein
the sensor is an angular speed sensor, and
the angular speed sensor is provided between an uppermost shelf and a lowermost shelf of the plurality of shelves.

14. The rack according to claim 12, wherein
the sensor is an acceleration sensor, and
the acceleration sensor is provided on an uppermost shelf of the plurality of shelves.

15. The rack according to claim 12, wherein the sensor is a weight sensor.

16. The rack according to claim 12, wherein the weight sensor is provided to each of the plurality of shelves.

17. The rack according to claim 12, wherein the weight sensor is provided to each of the plurality of legs.
